(19) United States
(12) Patent Application Publication
(10) Pub. No.: US 2015/0347972 A1
(43) Pub. Date: Dec. 3, 2015

(54) ENGINEERING TOOL AND ENGINEERING SYSTEM

(71) Applicant: MITSUBISHI ELECTRIC CORPORATION, Tokyo (JP)

(72) Inventors: Takayuki YAMAOKA, Tokyo (JP); Nobuhiro ITO, Tokyo (JP)

(73) Assignee: MITSUBISHI ELECTRIC CORPORATION, Tokyo (JP)

(21) Appl. No.: 14/761,448

(22) PCT Filed: Feb. 20, 2013
(86) PCT No.: PCT/JP2013/054130

§ 371 Date: Jul. 16, 2015

(51) Int. Cl. G06Q 10/10

(52) U.S. Cl. CPC G06Q 10/101

(57) ABSTRACT

An engineering tool including: an operation-history management unit that records content of an operation performed in project creation together with a work type set for each work content of the project creation and manages recorded data as an operation history of the project creation; and an operation-history display unit that displays content of the operation history read from the operation-history management unit, wherein when work of the project creation is resumed after interruption, the operation-history display unit hierarchically displays the content of the operation included in the operation history for each work type.

### FIELD

The present invention relates to an engineering tool and an engineering system for creating a sequence program.

### BACKGROUND

In the creation of a sequence program, a worker creates a project and creates a program and parameter settings in the project. Generally, during the process from start to completion of creating a project, there is a period during which the creation work of the worker is interrupted. When the project creation work is resumed after the interruption, the worker first checks the current progress status of the work and then continues the work that has been interrupted.

Conventionally, a worker estimates how far the work has progressed before the work was interrupted by tracing back through the memory to find the status before interruption of the work. In this case, it sometimes takes a long time to check the progress status of the work. Further, when the worker has a vague memory or the progress status is not sufficiently checked, the worker performs the work that has already been performed again or the worker may mistakenly assume that the work that has not been completed has been completed, causing the work to be omitted. If another worker takes over the project creation work after the interruption, much time and effort may be required for the handover of the work.

For example, with regard to an integrated-project management tool that manages a project corresponding to an automation system such as FA, Patent Literature 1 discloses a technology for providing a unit that manages the change history of the content of a project. With regard to a project-management support program, Patent Literature 2 discloses a technology for storing the tasks expressed in a tree structure and editing the execution history of the tasks. Patent Literature 3 discloses a technology for presenting the operation history information to the user when the system user continues an operation with a time interval.

### CITATION LIST

### Patent Literatures

Patent Literature 1: Japanese Patent Application Laid-open No. 2002-222300 Patent Literature 2: Japanese Patent Application Laid-open No. 2007-249572

Patent Literature 3: Japanese Patent Application Laid-open No. 2004-171252

### SUMMARY

### Technical Problem

Patent Literatures 1 and 3 do not disclose enabling the progress status of the project creation work to be easily ascertained by hierarchically managing the project. With the technology in Patent Literature 2, it is difficult to ascertain the progress status of the work for each content of the work types; therefore, much time and effort may be required to check the progress status of the work. According to the conventional technologies, the work efficiency when creating a sequence program may be reduced as a result of the time and effort taken to ascertain the progress status of the project creation work.

The present invention has been achieved in view of the above problems, and an object of the present invention is to provide an engineering tool and an engineering system with which the progress status of project creation work can be easily ascertained to enable improvement in the work efficiency.

### Solution to Problem

In order to solve the above problems and achieve the object, an aspect of the present invention is an engineering tool including: an operation-history management unit that records content of an operation performed in project creation together with a work type set for each work content of the project creation and manages recorded data as an operation history of the project creation; and an operation-history display unit that displays content of the operation history read from the operation-history management unit, wherein when work of the project creation is resumed after interruption, the operation-history display unit hierarchically displays the content of the operation included in the operation history for each work type.

### Advantageous Effects of Invention

According to the engineering tool of the present invention, the content of operations included in an operation history are hierarchically displayed for each work type. Therefore, the worker can easily ascertain the progress status of each work type according to the display. Accordingly, an effect is obtained where the progress status of the project creation work can be easily ascertained.

### BRIEF DESCRIPTION OF DRAWINGS

FIG. 1 is a conceptual diagram explaining functions of an engineering tool and an engineering system according to the present invention.

FIG. 2 is a diagram illustrating a basic configuration of an engineering tool according to a first embodiment of the present invention.

FIG. 3 is a diagram illustrating an example of display by an operation-history display unit.

FIG. 4 is a diagram illustrating an example of the content of an operation/work type correspondence table.

FIG. 5 is a diagram illustrating an example of a user operation by a user-operation input unit together with the operation sequence.

FIG. 6 is a diagram illustrating an example of an operation history managed by an operation-history management unit.

FIG. 7 is a flowchart explaining a procedure from a user operation until creation of operation history data.

FIG. 8 is a flowchart explaining a procedure until the content of an operation history is displayed when project creation is resumed.

FIG. 9 is a conceptual diagram explaining functions of an engineering tool according to a second embodiment of the present invention.

FIG. 10 is a conceptual diagram explaining functions of an engineering tool according to a third embodiment of the present invention.

FIG. 11 is a diagram illustrating an example of the content of an operation/work type correspondence table.

### DESCRIPTION OF EMBODIMENTS

Exemplary embodiments of an engineering tool and an engineering system according to the present invention will be explained below in detail with reference to the accompanying drawings. The present invention is not limited to the embodiments.

### First Embodiment

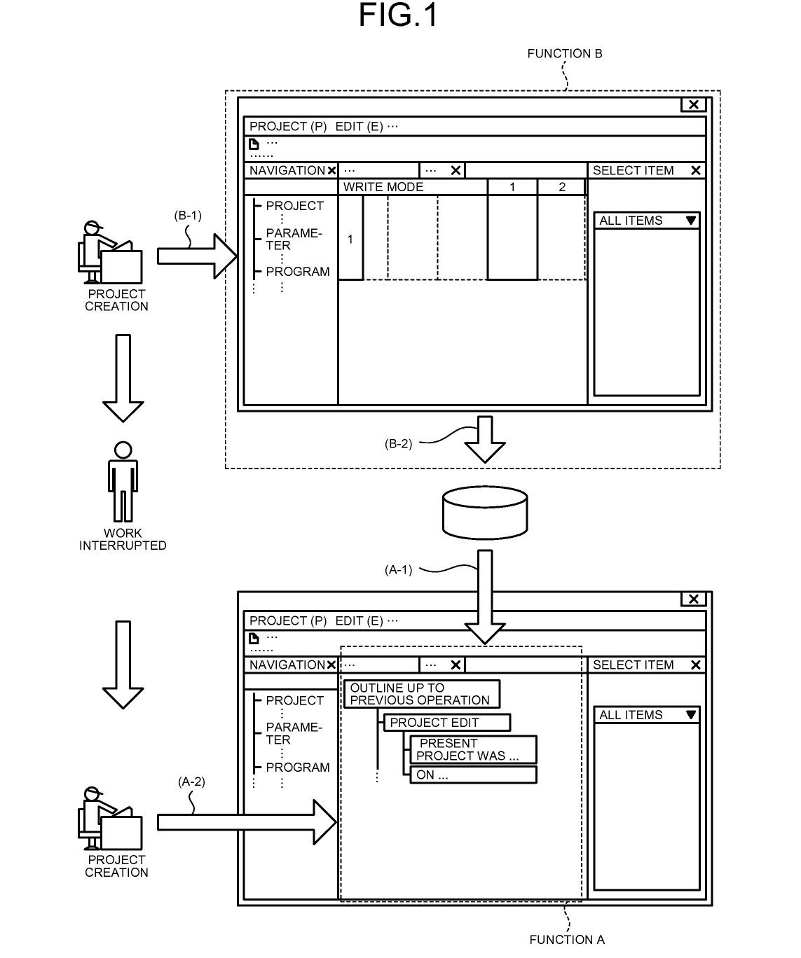

FIG. 1 is a conceptual diagram explaining functions of an engineering tool and an engineering system according to the present invention. The present invention provides a function A and a function B described below to resolve the above problems.

Function A: when the worker resumes project creation work after interruption, the engineering tool displays the content of the operation history before the interruption. The content of the operation history is displayed hierarchically for each work type.

Function B: the engineering tool automatically records the content of an operation performed during project creation and holds the recorded data as operation history data. In the operation history data, the content of the operation is associated with the work type for which the operation is performed. The operation history data held by the function B is used for hierarchical display by the function A.

As illustrated in FIG. 1, when the worker performs an operation for project creation (B-1), the engineering tool records the content of the operation (B-2). When the worker resumes the work after interruption of the work, the engineering tool displays the content of the work history that has been read (A-1). The worker checks the displayed content of the operation history (A-2) and resumes the project creation work.

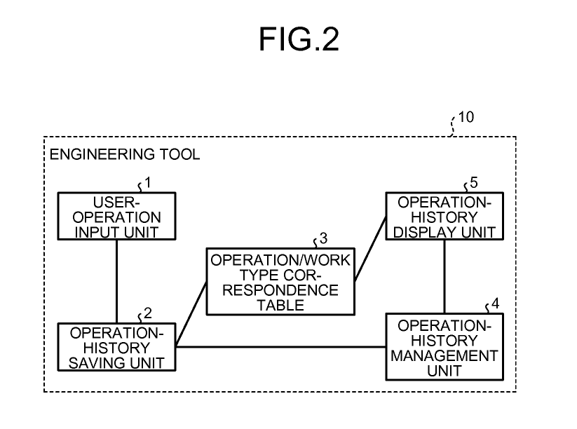

FIG. 2 is a diagram illustrating a basic configuration of an engineering tool according to a first embodiment of the present invention. An engineering tool 10 is a tool that edits a program that runs in a programmable logic controller (PLC) system. The engineering tool 10 is realized as software on a personal computer.

The engineering tool 10 includes a user-operation input unit 1, an operation-history saving unit 2, an operation/work type correspondence table 3, an operation-history management unit 4, and an operation-history display unit 5.

The user-operation input unit 1 is a unit that recognizes a mouse operation, key input, and the like on the screen of the engineering tool 10. The user-operation input unit 1 receives an input operation (a user operation) by the user. The user-operation input unit 1 includes, for example, a menu display on the screen and an editor (a program editing screen).

The operation-history saving unit 2 receives the content of an user operation performed in the project creation from the user-operation input unit 1. The operation-history saving unit 2 acquires the operation ID corresponding to the content of the user operation from the operation/work type correspondence table 3. The operation-history saving unit 2 transmits input data input by the user operation and the operation ID acquired from the operation/work type correspondence table 3 to the operation-history management unit 4.

The operation/work type correspondence table 3 is a table that defines a correspondence between the user operation and the work type. The operation/work type correspondence table 3 holds in advance the correspondence relation between the user operation and the work type together with the operation ID. The work type is set in advance for each content of the project creation work. The operation ID is identification information added in advance to the combination of the content of the user operation and the work type corresponding thereto.

The operation-history management unit 4 records the input data and the operation ID acquired from the operation-history saving unit 2 together with the operation date and time when the operation is performed. The operation-history management unit 4 manages the recorded data as an operation history of the project creation. The operation-history management unit 4 holds the content of the user operation performed in the project creation and the work type thereof as a combination of the operation ID and the input data. The operation-history management unit 4 manages the operation history for each project.

The operation-history display unit 5 displays the content of the operation history read from the operation-history management unit 4. When the project creation work is resumed after interruption, the operation-history display unit 5 hierarchically displays the content of the user operation included in the operation history for each work type.

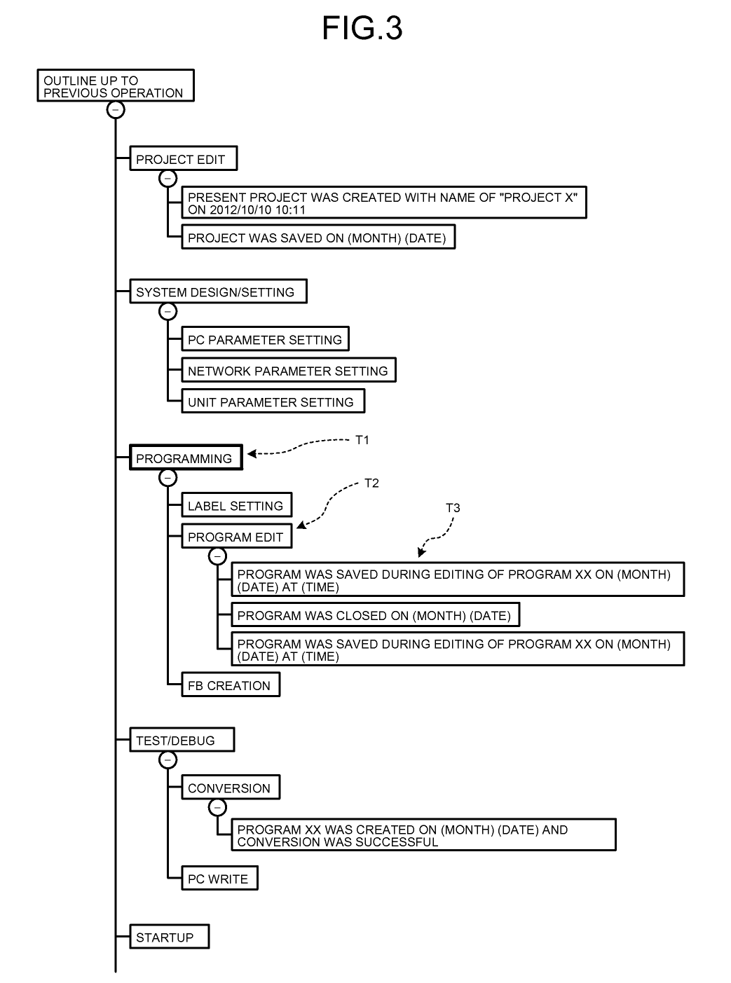

FIG. 3 is a diagram illustrating an example of display by the operation-history display unit. In the present embodiment, the operation-history display unit 5 uses three hierarchies, i.e., a first work type (T1), a second work type (T2), and a detailed operation (T3), to display the content of the operation history. The first work type is defined by dividing the work in the project creation into general types and the second work type indicates the work type included under the first work type. The detailed operation indicates details of the user operation in each work.

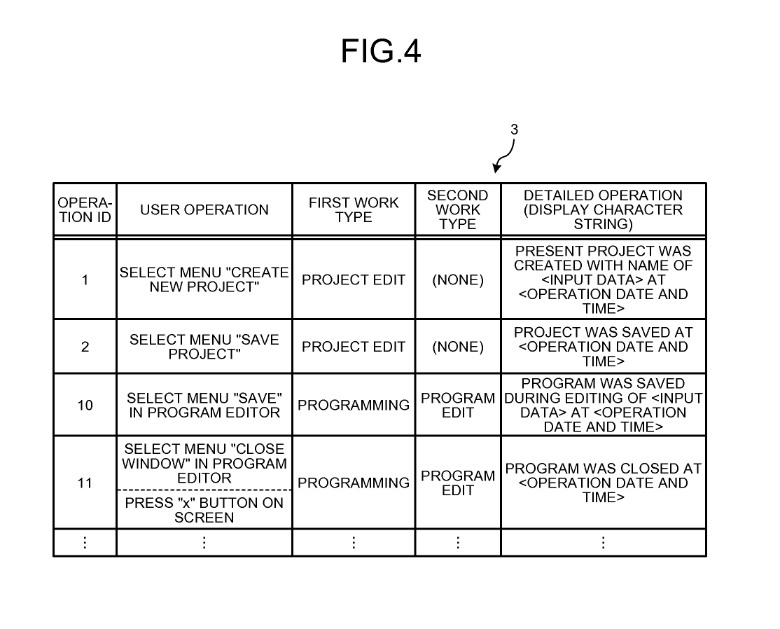

FIG. 4 is a diagram illustrating an example of the content of the operation/work type correspondence table. The operation/work type correspondence table 3 holds operation ID, user operation associated with the operation ID, first work type, second work type, and detailed operation. In the operation/work type correspondence table 3, the detailed operation is recorded as a display character string.

For example, the operation ID “1” is added to the user operation “select menu “create new project””. The user operation is associated with the first work type “project edit” and the detailed operation “present project was created with name of <input data> at <operation date and time>”.

The <input data> in the character string of the detailed operation is assumed to be a variable part that can be replaced by input data to be input by the user operation. The <operation date and time> in the character string of the detailed operation is assumed to be a variable part that can be replaced by the operation date and time when the user operation is performed. The first work type includes a type that does not include a setting of the second work type under it, such as “project edit”.

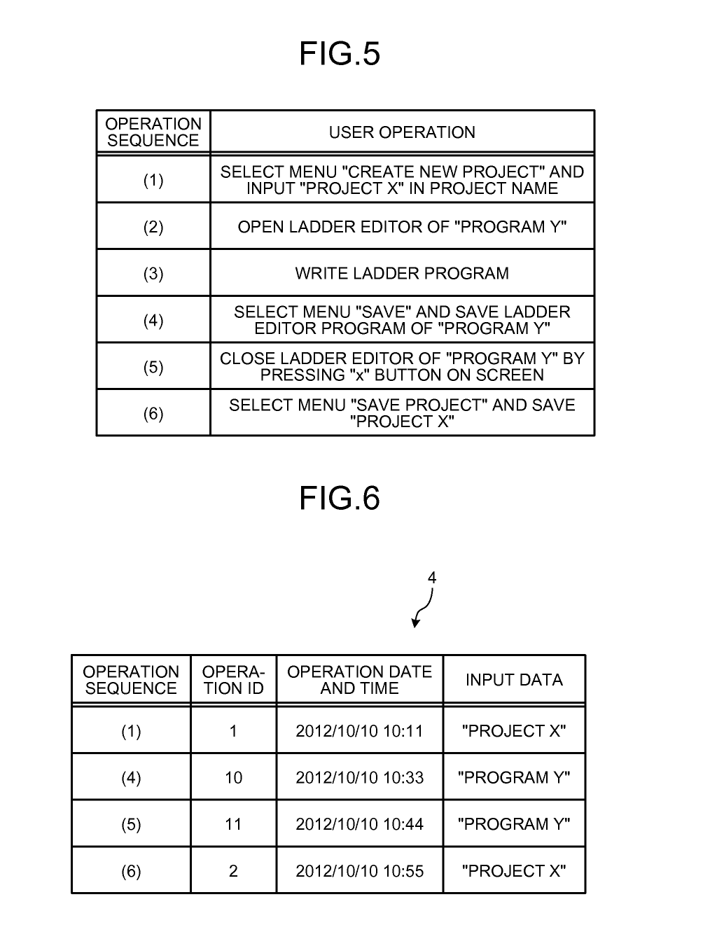

FIG. 5 is a diagram illustrating an example of the user operation by the user-operation input unit together with the operation sequence. FIG. 6 is a diagram illustrating an example of the operation history managed by the operation-history management unit. The operation-history management unit 4 holds operation ID, operation date and time, and input data with respect to an operation associated with the operation ID in the operation/work type correspondence table 3 from the operation sequence illustrated in FIG. 5.

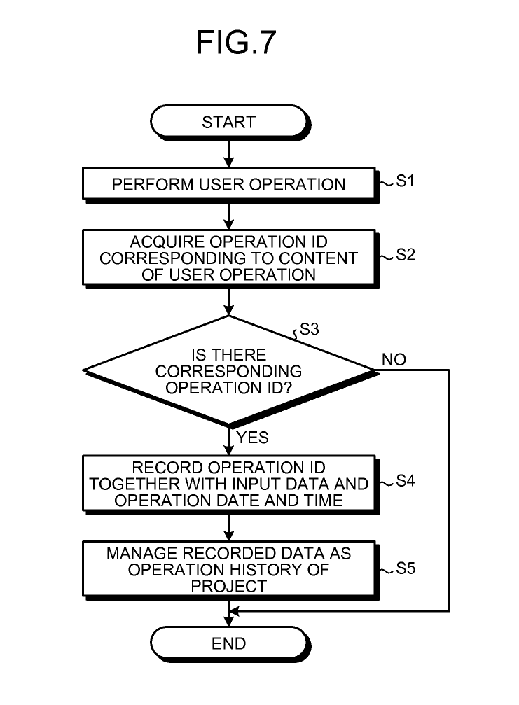

An operation from the user operation until creation of the operation history data is described here with reference to FIG. 2, and FIGS. 4 to 7 for a case where the user operation illustrated in FIG. 5 is performed as an example. FIG. 7 is a flowchart explaining a procedure from the user operation until creation of the operation history data.

For example, in the operation sequence (1), it is assumed that the user operation “select menu “create new project” and input “project X” in project name” has been performed by the user-operation input unit 1 (Step S1). The user-operation input unit 1 transmits the content of the user operation to the operation-history saving unit 2.

The operation-history saving unit 2 receives the content of the user operation from the user-operation input unit 1. The operation-history saving unit 2 acquires the operation ID corresponding to the content of the user operation from the operation/work type correspondence table 3 (Step S2). With regard to the operation sequence (1), the operation-history saving unit 2 acquires the operation ID corresponding to selection of the menu “create new project” from the operation/work type correspondence table 3.

In the operation/work type correspondence table 3, there is the operation ID “1” corresponding to the selection of the menu “create new project”. As in the operation sequence (1), when there is the operation ID corresponding to the content of the user operation in the operation/work type correspondence table 3 (YES at Step S3), the operation-history saving unit 2 transmits the operation ID acquired from the operation/work type correspondence table 3 to the operation-history management unit 4.

The operation-history saving unit 2 transmits, to the operation-history management unit 4, the input data input by the user operation and the operation date and time together with the operation ID. The operation-history management unit 4 records the operation ID, the input data, and the operation date and time transmitted from the operation-history saving unit 2 (Step S4).

With regard to the operation sequence (1), the operation-history management unit 4 records the operation ID “1”, input data “project X”, and operation date and time “2012/10/10 10:11”. The operation-history management unit 4 manages the recorded data as operation history data of the project (Step S5). When the above operation is complete for one operation sequence, the engineering tool 10 repeats the operation from Step S1 for the next operation procedure.

In the operation procedure (2) subsequent to the operation procedure (1), it is assumed that the user operation “open ladder editor of “program Y”” is performed by the user-operation input unit 1 (Step S1). The user-operation input unit 1 transmits the content of the user operation to the operation-history saving unit 2.

The operation-history saving unit 2 receives the content of the user operation from the user-operation input unit 1. The operation-history saving unit 2 attempts to acquire the operation ID corresponding to the content of the user operation (Step S2). There is no operation ID corresponding to opening the ladder editor in the operation/work type correspondence table 3.

Because there is no operation ID corresponding to the content of the user operation with regard to the operation sequence (2) (NO at Step S3), the engineering tool 10 does not record the data in the operation-history management unit 4. The engineering tool 10 repeats the operation from Step S1 for the next operation procedure.

In the operation procedure (3) subsequent to the operation procedure (2), it is assumed that the user operation “write ladder program” is performed by the user-operation input unit 1 (Step S1). There is no operation ID corresponding to the content of the user operation with regard to the operation sequence (3) in the operation/work type correspondence table 3 (NO at Step S3). Accordingly, also with regard to the operation procedure (3), the engineering tool 10 does not record the data in the operation-history management unit 4 as in the operation procedure (2).

In the operation procedure (4) subsequent to the operation procedure (3), it is assumed that the user operation “select menu “save” and save ladder editor program of “program Y”” is performed by the user-operation input unit 1 (Step S1). There is an operation ID corresponding to the content of the user operation with regard to the operation sequence (4) in the operation/work type correspondence table 3 (YES at Step S3). With regard to the operation sequence (4), the operation-history management unit 4 records the operation ID “10”, input data “program Y”, and operation date and time “2012/10/10 10:33” (Step S4).

In the operation procedure (5) subsequent to the operation sequence (4), it is assumed that the user operation “close ladder editor of “project Y” by pressing “x” button on screen” is performed by the user-operation input unit 1 (Step S1). There is an operation ID corresponding to the content of the user operation with regard to the operation sequence (5) in the operation/work type correspondence table 3 (YES at Step S3). With regard to the operation sequence (5), the operation-history management unit 4 records the operation ID “11”, input data “program Y”, and operation date and time “2012/10/10 10:44” (Step S4).

In the operation procedure (6) subsequent to the operation sequence (5), it is assumed that the user operation “select menu “save project” and save “project X”” is performed by the user-operation input unit 1 (Step S1). There is an operation ID corresponding to the content of the user operation with regard to the operation sequence (6) in the operation/work type correspondence table 3 (YES at Step S3). With regard to the operation sequence (6), the operation-history management unit 4 records the operation ID “2”, input data “project X”, and operation date and time “2012/10/10 10:55” (Step S4).

The engineering tool 10 repeats the procedures from Step S1 to Step S5 until the project creation work is interrupted or the project creation is complete, to create operation history data. The engineering tool 10 creates operation history data for each project.

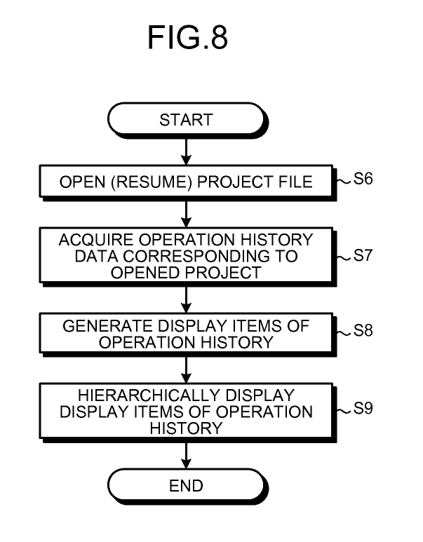

An operation for displaying the content of operation history data when the user resumes the project creation after interruption is described with reference to FIGS. 2 to 4 and FIGS. 6 and 8. FIG. 8 is a flowchart explaining a procedure until the content of an operation history is displayed when the project creation is resumed.

For example, it is assumed that the user opened the file “project X” in order to resume creation of “project X” (Step S6). The operation-history display unit 5 acquires the operation history data corresponding to “project X” that is the opened project from the operation-history management unit 4 (Step S7).

The operation-history display unit 5 reads a display character string of the detailed operation corresponding to each operation ID in the acquired operation history data from the operation/work type correspondence table 3. The operation-history display unit 5 reads the first work type and the second work type corresponding to each operation ID in the acquired operation history data from the operation/work type correspondence table 3. The operation-history display unit 5 creates display items of the operation history (Step S8).

For example, with respect to the operation ID “1”, the operation-history display unit 5 acquires a display character string of the detailed operation “present project was created with name of <input data> at <operation date and time>”.

The operation-history display unit 5 replaces the variable part in the acquired display character string of the detailed operation with the operation history data. For example, the operation-history display unit 5 performs replacement described below in the display character string with respect to the operation ID “1”.

<input data>=“project X”

<operation date and time>=2012/10/10 10:11

The operation-history display unit 5 generates a character string of the detailed operation “present project was created with name of “project X” on 2012/10/10 10:11” by replacement of the variable part. The operation-history display unit 5 acquires the first work type “project edit” with respect to the operation ID “1”.

The operation-history display unit 5 hierarchically displays the display items in the operation history generated at Step S8 by the first work type (T1), the second work type (T2), and the detailed operation (T3) (Step S9). For example, with regard to the operation procedure (1) illustrated in FIG. 5, the operation-history display unit 5 arranges, in a tree format, the character string of the detailed operation “present project was created with name of “project X”. . . ” generated at Step S8 under the first work type “project edit”.

With the above process, the engineering tool 10 hierarchically displays the content of the operations included in the operation history for each work type. According to such hierarchical display for each work type, the worker can check operations performed in the previous work at a glance. Therefore, it is not necessary for the worker to spend time checking the progress status of the project or estimating how far the work has progressed by tracing back through the memory as in the conventional case.

It is possible to prevent the worker from performing work that has already been performed again or prevent the worker from mistakenly assuming that work that has not been completed has been completed, causing the work to be omitted. If another worker takes over project creation work after interruption, it is possible to considerably reduce explanation of the progress status; therefore, handover of the work is facilitated.

Furthermore, by hierarchically displaying the content of operations for each work type, the worker can check the details of a required part after generally ascertaining the work. Accordingly, the engineering tool 10 has such an effect that the progress status of project creation work can be easily ascertained and thus the work efficiency can be improved.

The operation-history display unit 5 can further include a function of displaying “operation-target screen”, “operation-target data”, and “operator (user)” in addition to “operation date and time”, as the display items of the operation history. Accordingly, the content of an operation becomes easy to understand and the previous work can be easily recalled.

The operation-history display unit 5 can have a function of highlighting the work type for which an operation has not been performed when the operation history is displayed. For example, the operation-history display unit 5 highlights the character string by changing its color. Highlighting can be performed in any mode as long as the character string to be emphasized can be easily recognized visually. Consequently, the user can easily ascertain the work content for which an operation has not been performed and work can be prevented from being omitted.

The operation-history display unit 5 can have a function of performing highlighting on an uncompleted operation when the operation history is displayed. The uncompleted operation is, for example, a program in an unconverted state or a program having an error. Also in this case, highlighting can be performed in any mode, for example, by changing the color of the character string. Consequently, the user can easily ascertain the uncompleted operation and work can be prevented from being omitted. The engineering tool 10 can have a function of searching for a character string of the detailed operation. Accordingly, the content of the operations that have been already performed can be easily found.

### Second Embodiment

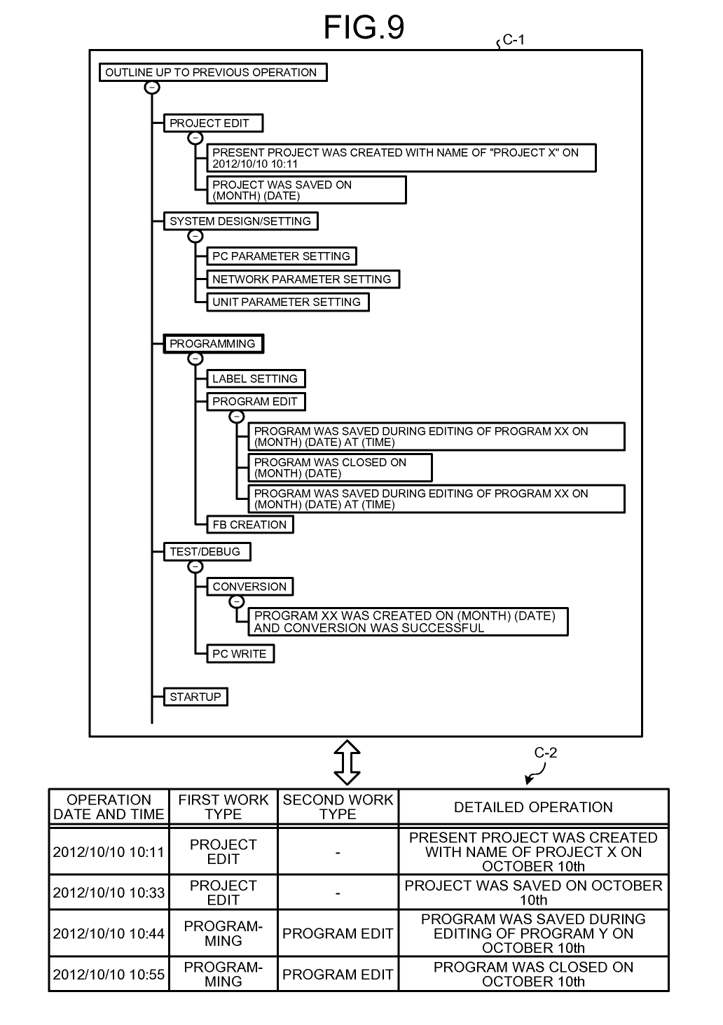

FIG. 9 is a conceptual diagram explaining functions of an engineering tool according to a second embodiment of the present invention. The engineering tool according to the present embodiment has a configuration similar to that of the engineering tool 10 (see FIG. 2) according to the first embodiment.

In the second embodiment, the operation-history display unit 5 can switch the content of operations included in the operation history between hierarchical display for each work type (C-1) and time-series display in project creation (C-2). Hierarchical display of the present embodiment is similar to that of the first embodiment.

The engineering tool according to the present embodiment performs hierarchical display by the operation similar to that performed by the engineering tool according to the first embodiment. When switching from hierarchical display to time-series display is instructed, the operation-content display unit 5 changes the display of the operation history to time-series display in order of the operation date and time. When switching from time-series display to hierarchical display is instructed, the operation-content display unit 5 changes the display of the operation history to hierarchical display for each work type.

According to the present embodiment also, the engineering tool enables the progress status of the project creation work to be easily ascertained by hierarchical display of a work history and thus can improve the work efficiency. The engineering tool also enables the order of the project creation work to be easily ascertained by time-series display of a work history.

### Third Embodiment

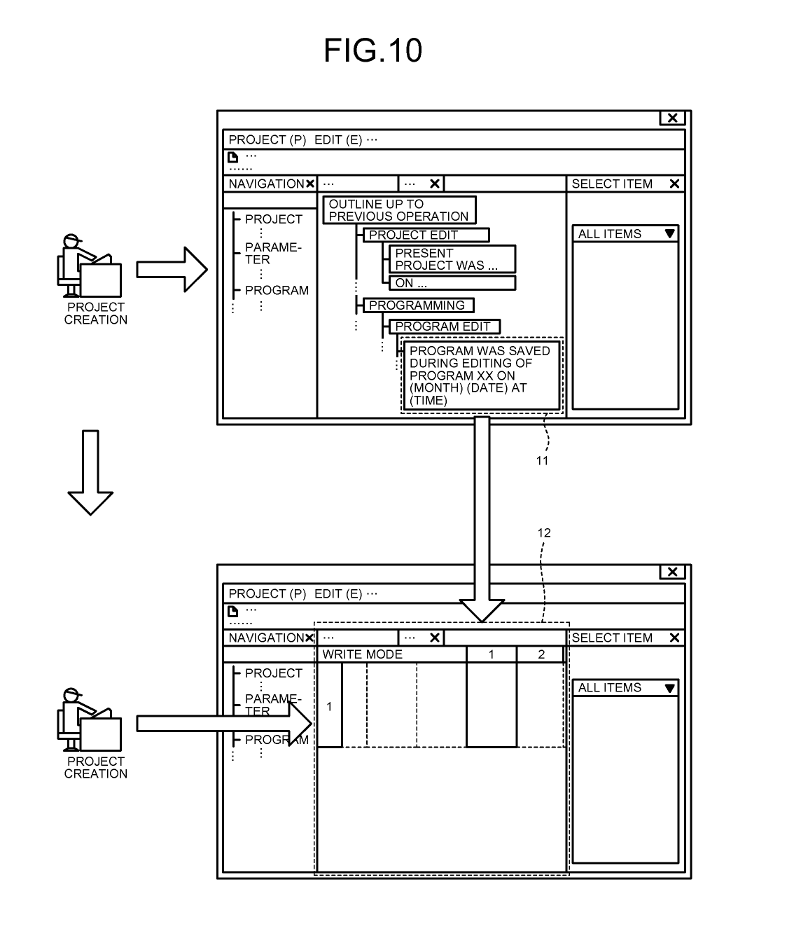

FIG. 10 is a conceptual diagram explaining functions of an engineering tool according to a third embodiment of the present invention. The engineering tool according to the present embodiment has a configuration similar to that of the engineering tool 10 (see FIG. 2) according to the first embodiment.

According to the third embodiment, when the user specifies a certain detailed operation 11 from the display of an operation history on the operation-history display unit 5, the engineering tool opens a work screen 12 corresponding to the specified detailed operation 11.

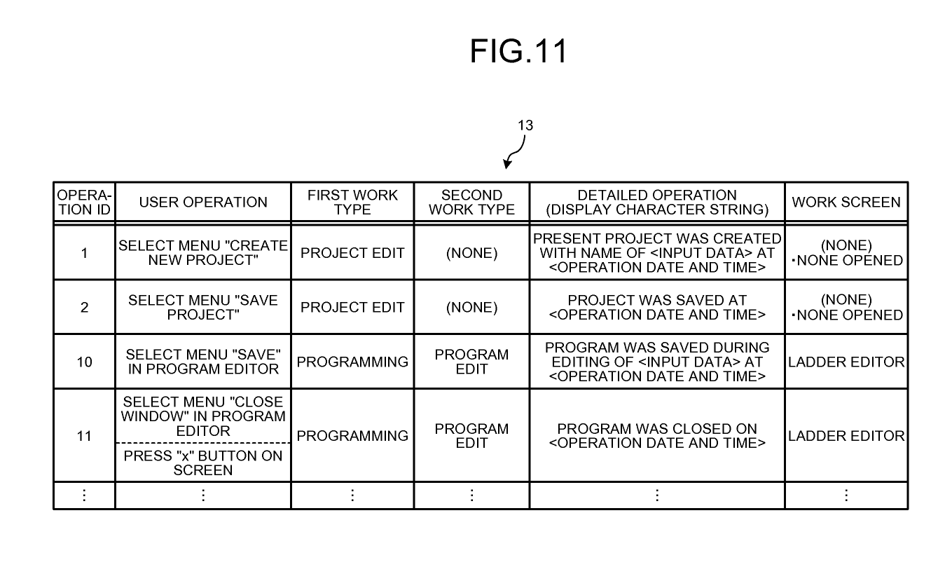

FIG. 11 is a diagram illustrating an example of the content of an operation/work type correspondence table. An operation/work type correspondence table 13 holds operation ID, user operation associated with the operation ID, first work type, second work type, and detailed operation as in the operation/work type correspondence table 3 of the first embodiment (see FIG. 4). The operation/work type correspondence table 13 also holds information relating to the work screen corresponding to the detailed operation.

For example, when the detailed operation 11 is specified by double-clicking on the operation-history display unit 5, the operation-history display unit 5 acquires information relating to the work screen corresponding to the detailed operation 11 from the operation/work type correspondence table 13. The operation-history display unit 5 displays the work screen 12 in accordance with the information on the acquired work screen. The detailed operation includes an operation of not opening any work screen.

For example, as the detailed operation 11, it is assumed that the character string of the detailed operation corresponding to the operation procedure (4) illustrated in FIG. 5, i.e., “save program during editing of “program Y”” is double-clicked. The operation-history display unit 5 acquires information “ladder editor” relating to the work screen corresponding to the detailed operation 11 from the operation/work type correspondence table 13. The operation-history display unit 5 opens the ladder editor according to the information on the acquired work screen. The operation-history display unit 5 displays “program Y” in the ladder editor.

According to the present embodiment also, the engineering tool enables the progress status of the project creation work to be easily ascertained by hierarchical display of an operation history and thus can improve the work efficiency. The user can immediately start the project creation that has been interrupted by specifying the detailed operation 11 of work desired to continue from display of the operation history on the operation-history display unit 5.

The engineering tool according to each of the embodiments is provided by being recorded in a computer-readable recording medium in a file of an installable format or an executable format. The engineering tool can be such that it is stored in a computer connected to a network such as the Internet and is provided via the network.

The functions of the engineering tool described in each of the embodiments can be realized by an engineering system including a server and a terminal connected to a network. The engineering system can be such that a server has the functions, for example, up to generating the display items of the operation history, and the content of the operation history is displayed on a terminal connected to the server via the network.

### REFERENCE SIGNS LIST

1 user-operation input unit, 2 operation-history saving unit, 3 operation/work type correspondence table, 4 operation-history management unit, 5 operation-history display unit, 10 engineering tool, 11 detailed operation, 12 work screen, 13 operation/work type correspondence table.

1. An engineering tool comprising:
an operation-history management unit that records content of an operation performed in project creation together with a work type set for each work content of the project creation and manages recorded data as an operation history of the project creation; and
an operation-history display unit that displays content of the operation history read from the operation-history management unit, wherein
when work of the project creation is resumed after interruption, the operation-history display unit is capable of switching the content of the operation included in the operation history between hierarchical display, which is hierarchically displaying the content of the operation for each work type, and time-series display in the project creation.

2. (canceled)

3. The engineering tool according to claim 1, wherein the operation-history display unit highlights the work type for which an operation has not been performed when the content of the operation history is displayed.

4. The engineering tool according to claim 1, wherein the operation-history display unit highlights an uncompleted operation when the content of the operation history is displayed.

5. The engineering tool according to claim 1, wherein the operation-history display unit displays a work screen for an operation specified from display of the content of the operation history.

6. An engineering system comprising:
an operation-history management unit that records content of an operation performed in project creation together with a work type set for each work content of the project creation and manages recorded data as an operation history of the project creation; and
an operation-history display unit that displays content of the operation history read from the operation-history management unit, wherein
when work of the project creation is resumed after interruption, the operation-history display unit is capable of switching the content of the operation included in the operation history between hierarchical display, which is hierarchically displaying the content of the operation for each work type, and time-series display in the project creation.
